(19) United States
(12) Patent Application Publication
(10) Pub. No.: US 2021/0209965 A1
(43) Pub. Date: Jul. 8, 2021

(54) INFANT PERICARDIOCENTESIS TRAINER FOR USE WITH ULTRASOUND

(71) Applicant: University of Tennessee Research Foundation, Knoxville, TN (US)

(72) Inventors: Jonathan C. Spagnoli, Memphis, TN (US); Ranjit Raju Philip, Memphis, TN (US); Sandeep Chilakala, Germantown, TN (US); Jarrod Young, Arlington, TN (US)

(21) Appl. No.: 17/140,824

(22) Filed: Jan. 4, 2021

Related U.S. Application Data
(60) Provisional application No. 62/956,990, filed on Jan. 3, 2020.

(51) Int. Cl. G09B 23/28; G09B 23/30

(52) U.S. Cl. CPC G09B 23/286; G09B 23/303

(57) ABSTRACT

The present subject matter relates to systems, devices, and methods for pericardiocentesis training that includes an inner fluid chamber, a first conduit connected to the inner fluid chamber and configured to provide passage of a first fluid into or out of the inner fluid chamber, an outer fluid chamber substantially surrounding the inner fluid chamber, and a second conduit connected to the outer fluid chamber and configured to provide passage of a second fluid into or out of the outer fluid chamber. Such system and devices are configured to model a human patient during medical testing procedures in which a needle is manipulated into the training device while simultaneously observing the needle by ultrasound or other imaging device.

### PRIORITY CLAIM

The present application claims the benefit of U.S. Provisional Patent Ser. No. 62/956,990, filed Jan. 3, 2020, the disclosure of which is incorporated herein by reference in its entirety.

### TECHNICAL FIELD

The subject matter disclosed herein relates generally to systems, devices, and methods for medical procedure training. More particularly, the subject matter disclosed herein relates to systems, devices, and methods for pericardiocentesis training.

### BACKGROUND

Cardiac tamponade is a life-threatening condition characterized by fluid accumulation in the pericardium, which externally compresses the cardiac chamber, impairs diastolic filling, and can lead to clinical shock.

Pericardiocentesis is the definitive emergent life-saving treatment for tamponade; however, it remains a challenge for trainees because of the infrequent exposure compared to other invasive procedures, especially in the neonatal and pediatric population. This technique, unlike others, can lead to serious complications if not performed correctly, including cardiac perforation and arrhythmia.

There are over 950 Neonatal Intensive Care Units (NICU) in the United States that are managed by over 8000 neonatologists. Currently, 85% of NICUs lack interventional pediatric cardiologists, who specialize in catheter interventions and invasive procedures. In addition, there is a lack of training and specialization in this area during medical training/residency due to the rarity of the condition. Further in this regard, neonatal and pediatric patients present particular challenges to pericardiocentesis. Size is the main difference, which is very important because the margin of error is smaller (i.e., a few mm here and here makes a big difference in terms of high risk of myocardium or coronary laceration and arrhythmia). In addition, the infant heart differs from that of older children and adults in proportion, form, and position in the thorax, and thus pericardiocentesis training methodologies that are designed based on adult patient models provide a poor platform on which to train for neonatal and pediatric procedures.

Therefore, there is an unmet need for systems and method for training medical practitioners to effectively and safely perform pericardiocentesis on infants.

### SUMMARY

In accordance with this disclosure, systems, devices, and methods for pericardiocentesis training are provided. In one aspect, a medical procedure training device is provided. The medical procedure training device can include an inner fluid chamber, a first conduit connected to the inner fluid chamber and configured to provide passage of a first fluid into or out of the inner fluid chamber, an outer fluid chamber substantially surrounding the inner fluid chamber, and a second conduit connected to the outer fluid chamber and configured to provide passage of a second fluid into or out of the outer fluid chamber.

In another aspect, a medical procedure training system includes a medical procedure training device including an inner fluid chamber, a first conduit connected to the inner fluid chamber, an outer fluid chamber substantially surrounding the inner fluid chamber, and a second conduit connected to the outer fluid chamber. A first fluid source is provided in communication with first conduit and configured to provide passage of a first fluid into or out of the inner fluid chamber, and a second fluid source in communication with the second conduit and configured to provide passage of a second fluid into or out of the outer fluid chamber. An ultrasound device or other imaging device can be used with such a system as part of a medical training procedure.

In another aspect, a method of simulating an infant pericardiocentesis procedure is provided in which a medical procedure training device is provided including an inner fluid chamber and an outer fluid chamber substantially surrounding the inner fluid chamber. A needle can be manipulated into the training device while simultaneously observing the needle by ultrasound or other imaging device.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a schematic view of elements of a medical procedure training device according to an embodiment of the presently disclosed subject matter;

FIG. 2 is a front schematic view of a medical procedure training device according to an embodiment of the presently disclosed subject matter;

FIGS. 3-5 are perspective views of various configurations of a medical procedure training device according to embodiments of the presently disclosed subject matter; and

FIGS. 6-10 are side schematic views of steps in a process for producing a medical procedure training device according to embodiments of the presently disclosed subject matter.

### DETAILED DESCRIPTION

The present subject matter provides systems, devices, and methods for pericardiocentesis training. In one aspect, the present subject matter provides a training device that is particularly configured to substantially replicate a patient that is suffering from cardiac tamponade. Such training devices can be configured to be used with ultrasound or other imaging systems to allow a practitioner to observe the procedure in real-time, just as would be done in an actual pericardiocentesis procedure on a patient. In some particular embodiments, such training devices are sized, shaped, or otherwise configured to mimic an infant patient to facilitate training on smaller patients.

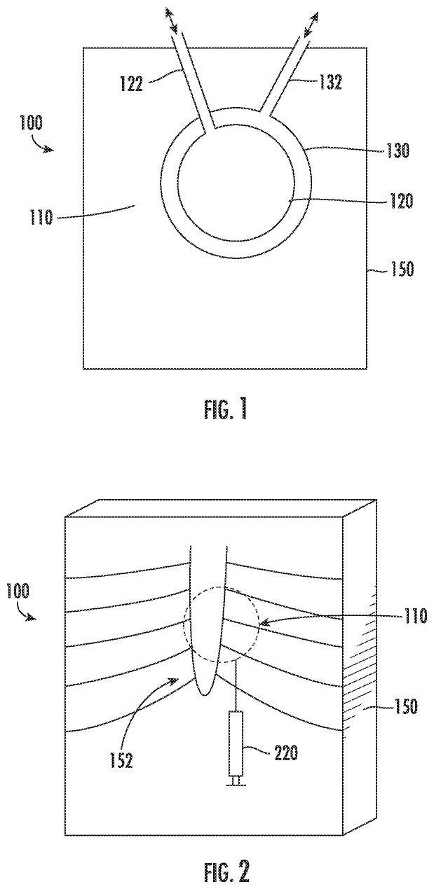

Referring to FIG. 1, a schematic representation of a pericardiocentesis training device, generally designated 100, is illustrated. Pericardiocentesis training device 100 can include a heart model, generally designated 110, that is positioned within a patient torso model 150. Heart model 110 can comprise an inner fluid chamber 120, which can be sized, shaped, or otherwise configured to model the heart of a patient. As illustrated in FIG. 1, in a representative embodiment of heart model 110, inner fluid chamber 120 is provided as a single substantially spherical or ovoid structure. In this configuration, the general size, shape, and/or volume of a heart can be effectively approximated. In some embodiments, for example, inner fluid chamber 120 has a size and shape configured to model an infant, an adolescent adult, and/or an adult patient. The size and thickness of inner fluid chamber 120 can vary based on the weight of the patient being modeled. In some particular embodiments, for example, inner fluid chamber 120 has a size that is considered standard for a 3.5 kg infant. For example, inner fluid chamber 120 can have a wall thickness of approximately 3.5 mm, which reflects the fact that the heart is a little thicker early in life (e.g., first few weeks). Alternatively or in addition, inner fluid chamber 120 can have a cavity size (i.e., left ventricular diastolic dimension) of approximately 20 mm. Those having ordinary skill in the art will recognize, however, that these dimensions are merely representative examples, and inner fluid chamber 120 can be configured to have different characteristics based on the patient to be modeled. That being said, in other embodiments, inner fluid chamber 120 can be modeled to more closely resemble the anatomical structure of a human heart, such as by including a characteristic shape and typical internal features of a human heart. For example, in some particular embodiments, inner fluid chamber 120 can comprise four sub-chambers having a spatial relationship designed to represent the four chambers of the human heart. Further, in some embodiments, inner fluid chamber 120 has a shape that includes structures that model the proximal portions of the great vessels (i.e., inferior vena cava, superior vena cava, pulmonary trunk/arteries, and pulmonary veins).

Heart model 110 also includes an outer fluid chamber 130 that substantially surrounds inner fluid chamber 120, with outer fluid chamber 130 being sized, shaped, or otherwise configured to model the pericardial space of a patient. In some embodiments, for example, outer fluid chamber 130 is sized and shaped to approximate the characteristics of a pericardial space for a given test scenario (i.e., having an amount of fluid depending on the severity of the pericardial effusion being modeled). Further in this regard, the thickness of the material that delimits outer fluid chamber 130 can be configured to model the characteristics of the patient being modeled. For example, in embodiments in which heart model 110 is configured to model the heart of an infant patient, outer fluid chamber 130 can have an outer material layer that is sized to approximate a typical infant heart that has a very thin epicardium compared to adult patients, which is representative of the situation in which fat layers are lacking.

Inner fluid chamber 120 is configured to receive therein a first fluid, and outer fluid chamber 130 configured to receive a second fluid that is separate from the first fluid. In some embodiments, for example, the first fluid and the second fluid can have different compositions and/or visual characteristics that allow them to be distinguished from one another when inspected during a medical test procedure. In some embodiments, the first fluid has a red color (e.g., water dyed with food coloring) and the second fluid has different color (e.g., substantially clear) that can be simply distinguished from the first fluid. Alternatively or in addition, the second fluid can have a color selected to model the type of pericardial effusion. For example, the second fluid can be a straw-colored fluid to approximate TPN fluid, or the second fluid can be a white-colored fluid to approximate chylous pericardial effusion. Regardless of the colors or characteristics used, the first and second fluids are configured such that, when aspirating fluid, the trainee can see if they accessed either the pericardial space (outer fluid chamber 130) or the heart (inner fluid chamber 120) by observing the characteristics of the fluid withdrawn. In addition, in some embodiments, the first fluid and/or the second fluid have a composition selected to limit growth of bacteria within heart model 110 (e.g., mixture of water and isopropyl alcohol).

In some embodiments, one or more first conduit 122 is connected to inner fluid chamber 120 and configured to provide passage of the first fluid into or out of inner fluid chamber 120. Similarly, one or more second conduit 132 can be connected to outer fluid chamber 130 and configured to provide passage of the second fluid into or out of outer fluid chamber 130. In some embodiments, a single conduit connected to each of inner fluid chamber 120 and outer fluid chamber 130 is sufficient to push fluid into the system, although those having skill in the art will recognize that the design can be reconfigured for multiple conduits to ensure that fluids fill up the connected chamber: one conduit can be configured to pass fluid into the corresponding space, and a second conduit can be used to pull out excess fluid. In some embodiments, such devices and systems can further comprise one or more first fluid source 124 in communication with the one or more first conduit 122 and one or more second fluid source 134 in communication with the one or more second conduit 132 (See, e.g., FIG. 4). Further, in some embodiments, one or more pump is configured for circulating the fluids into inner fluid chamber 120 and/or outer fluid chamber 130.

As discussed above, in some embodiments, the disclosed pericardiocentesis training device 100 can further comprise a patient torso model 150, wherein heart model 110 is contained within torso model 150. Patient torso model 150 can comprise simulated anatomical features, including for example, but not limited to, ribs, sternum and/or xiphoid process of an infant. As illustrated in FIG. 2, for example, in some embodiments, a surface texture or series of markings 152 can be provided on a surface of torso model 150 that simulates anatomical features on a patient. In some embodiments, for example, a hard polymer material is provided to act as palpable ribs/bony features. In addition, in some embodiments, torso model 150 further optionally includes one or more of an air-filled space on each side of heart model 110 to simulate lungs and/or a relatively higher density material provided in an upper right quadrant location of torso model 150 to simulate the liver in a subcostal ultrasound view.

In some embodiments, heart model 110 can be positioned within torso model 150 in a location that is at or near a true anatomical position of the heart relative to the simulated anatomical features. Specifically, for example, where pericardiocentesis training device 100 is configured to model an infant or adolescent patient, heart model 110 can have a relative proportion, form, and/or position within torso model 150 that is appropriate for the age of the modeled patient. In this regard, those having ordinary skill in the art will recognize that the thorax in newborn babies and infants has a relatively low height and greater depth than older children, the abdomen is relatively large, and the diaphragm is elevated. The heart in the infant, consequently, has a more horizontal position than in the adult. Anteriorly, it is covered by the lungs to a lesser extent than is the case for older patients. In many infant patients, the heart is relatively rounder and broader, with a proportionately bigger auricular part. The right side of the heart is fairly large in infancy, increasing the symmetry. The right margin of the heart is equally or near equally as rounded as the left. The cardiac apex is formed either by the right or the left ventricle, often by both. It is relatively rounder and bulkier than later in life. Accordingly, in some embodiments, heart model 110 is configured to be positioned within torso model 150 in a manner that corresponds to one or more of these characteristics.

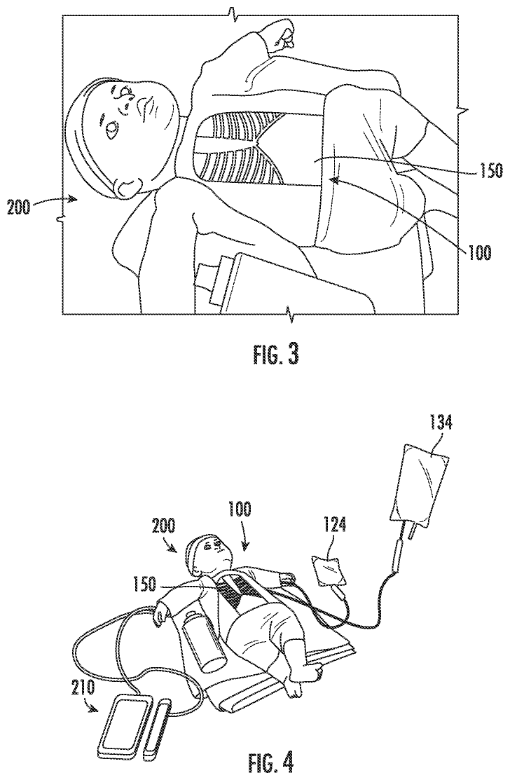

In addition, as illustrated in FIGS. 3 and 4, in some embodiments, torso model 150 can be integrated into a full patient model 200 (see FIGS. 3-5), such as a doll or dummy, to further simulate the relative size, position, and proportion of heart model 110 within a patient. Specifically, for example, as discussed above, in some embodiments, heart model 110 is sized, shaped, and/or positioned within torso model 150 and/or within full patient model 200 in a manner that substantially corresponds to the arrangement of the heart within an infant patient. As illustrated in FIG. 4, in some embodiments, the one or more first fluid source 124 and one or more second fluid source 134 (and pumps if included) can be located externally from patient model 200 to allow for control of flow of the fluids into or out of heart model 110 via first fluid conduit 122 and second fluid conduit 132. In some embodiments in which heart model 110 includes four chambers and/or great vessels to closely simulate human heart anatomy, for example, the one or more first fluid source 124 can be used to simulate blood flow. In such a configuration, flow parameters can be adjusted to increase or decrease the size of inner fluid chamber 120.

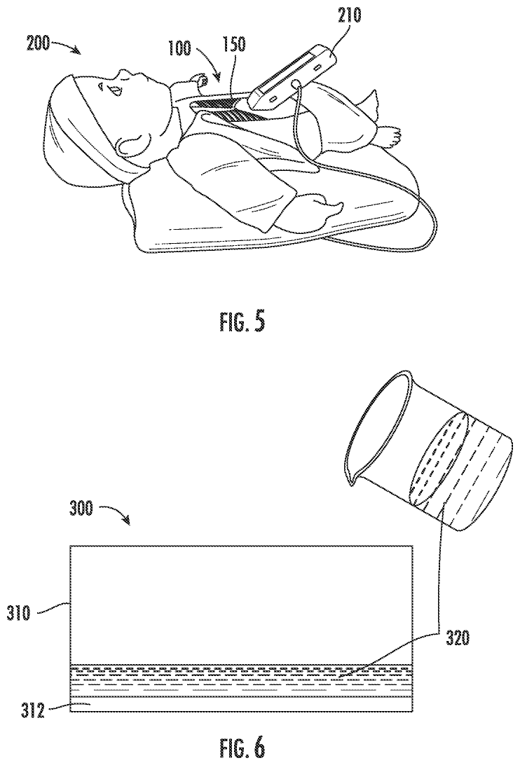

In any configuration, as illustrated in FIG. 5, in some embodiments, the device is designed and configured to be responsive to ultrasound or other imaging device 210 in a manner that is substantially similar to the response observed in a live patient. In such a configuration, pericardiocentesis training device 100 can provide a suitable model for pericardiocentesis training procedures in which a needle 220 can be inserted into the training device and/or system (See, e.g., FIG. 2) while simultaneously observing the needle 220 by ultrasound or other imaging device 210. In some embodiments, such devices and systems can also be used for, or configured for use for, thoracentesis and/or intracardiac injection procedures.

In some embodiments, for example, one or more elements of pericardiocentesis training device 100 comprises a material suitable for ultrasound or other imaging system, including but not limited to a thermoplastic elastomer, a silicone, a synthetic ballistic tissue, a polymer, or combinations thereof. The material used can be selected to have a density that is substantially similar to human tissue density and/or to otherwise produce a desired imaging response. Reflections at boundaries between two different media occur because of differences in a characteristic known as the acoustic impedance Z of each substance. Impedance is defined as Z=ρv, where ρ is the density of the medium (e.g., in kg/m3) and v is the speed of sound through the medium (e.g., in m/s).

In this regard, in some embodiments, inner fluid chamber 120 can be delimited by one or more material layer that comprises a material with a relatively higher density such that the brightness when imaged is higher than other structures to help trainees more readily identify the myocardium (i.e., heart muscle). Alternatively, in live patients, the acoustic impedances for soft tissue do not vary much, but that there is a big difference between the acoustic impedance of soft tissue and air and also between soft tissue and bone, which can be modeled by the material selections for the elements of pericardiocentesis training device 100. Accordingly, in some embodiments, both heart model 110 and torso model 150 are composed of solid materials with comparable ultrasound brightness, whereas outer fluid chamber 130 is filled with fluid to give the characteristic black appearance of the pericardial space. For instance, in some embodiments, inner fluid chamber 120 and outer fluid chamber 130 are each delimited by one or more material layer comprising a solid material having a density that is substantially similar to human tissue density. Further, in some embodiments, markings 152 can be composed of an even higher density material so that sound waves bounce back to the transducer more (and not pass through) to simulate the characteristic bright white image and acoustic shadow of bone. Regardless of the material used, the material can be configured such that no air bubbles are included therein, which can compromise the image. Further in this regard, the arrangement of elements and/or the thicknesses of the materials are designed and configured to allow imaging of heart model 110 in a manner that substantially mimics the imaging response of a live patient. In this way, pericardiocentesis training device 100 can provide a realistic response to imaging and pericardiocentesis for trainees.

To further enhance the ability of the model structures to be imaged, the fluids introduced into inner fluid chamber 120 and outer fluid chamber 130 can be selected or configured such that the first fluid can be distinguished from the second fluid upon inspection. For example, in some embodiments, the first fluid and second fluid are each of a different color. In this way, upon completion of a training procedure, the trainee can identify whether they successfully extracted the fluid only from outer fluid chamber 130 by observing the color of the fluid extracted.

To further illustrate the disclosed embodiments, in another aspect, a method for producing a pericardiocentesis training device 100 is provided. In this regard, FIGS. 6-9 provide a series of steps for at least one exemplary method of forming and developing pericardiocentesis training device 100. As illustrated in FIG. 6, in some embodiments, a fabrication station, generally designated 300, includes a mold cavity 310 that has a size, shape, and configuration that serves as a mold for torso model 150. In some embodiments, a mold base 312 of mold cavity 310 includes a negative impression of one or more typical anatomical features (e.g., ribs, sternum, and/or xyphoid process) to be integrated into a top surface of torso model 150 (See, e.g., to form markings 152 shown in FIG. 2). In some embodiments, mold base 312 is formed from clay, silicone, or any of a variety of other moldable materials into which the negative impression can be formed. In some embodiments, a hard polymer material is deposited in the mold to act as a palpable ribs/bony features as discussed above. A layer of tissue material 320 can be applied into the container to a desired depth (e.g., about 2 cm) at which the heart model will sit beneath the surface of the torso model. In some embodiments, tissue material 320 comprises a material that is suitable for modeling human tissue during the desired medical testing procedure. Examples of such materials include but are not limited to liquified thermoplastic elastomer, silicone, synthetic ballistic tissue, polymer, or combinations thereof. Tissue material 230 can be deposited into the container in a manner such that no air bubbles are included therein. Tissue material 320 can be cooled and/or cured until it is sufficiently solidified to build a next layer.

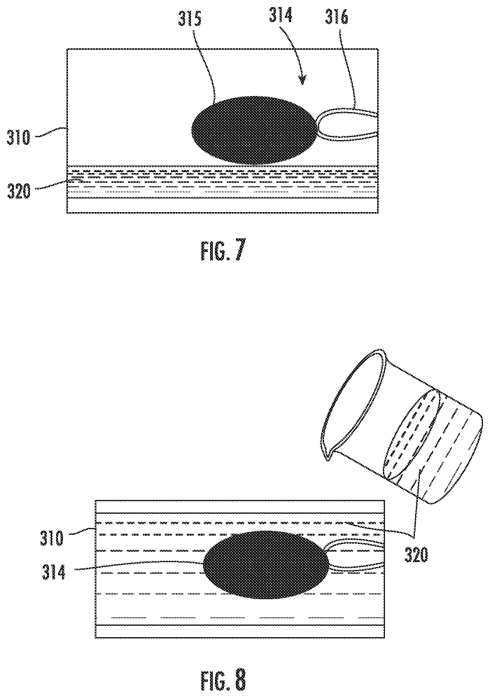

Referring next to FIG. 7, a heart mold 314 is placed upon the solidified layer of tissue material 320 in such a location that the pericardial space can be in an anatomically correct location with respect to the simulated anatomical features (e.g., ribs, sternum, and xyphoid process modeled by mold base 312). In some embodiments, heart mold 314 comprises a solid object 315 having a size and shape desired to represent the pericardial space, and one or more tube mold elements 316 are attached thereto to form the conduits in communication with each fluid chamber of heart model 110. Tube mold elements 316 can be trimmed such that their unattached ends are positioned at or near a side of mold cavity 310. In this way, access is provided to the conduits of heart model 110 when complete. In addition, in some embodiments, further molds can be positioned upon the solidified layer of tissue material 320 to simulate the size and position of other anatomical features (e.g., lungs).

Referring next to FIG. 8, additional tissue material 320 is provided in mold cavity 310 to substantially surround heart mold 314. Tissue material 320 is cooled and/or cured until solid to define torso model 150. Referring next to

FIG. 9, torso model 150 can be removed form mold cavity 310, and heart mold 314 can be removed from torso model 150. In some embodiments, a small incision can be made into torso model 150 using a scalpel, such as on a side of torso model opposite the modeled anatomical features. In removing heart mold 314, a cavity remains within the tissue material, with the space vacated by solid object 315 defining outer fluid chamber 130 and the space vacated by tube mold elements 316 defining channels into which the conduits of heart model 110 can be placed. The incision can further be used to insert the remaining structures of heart model 110—such as inner fluid chamber 120 and one or more first conduit 122 attached thereto—into torso model 150.

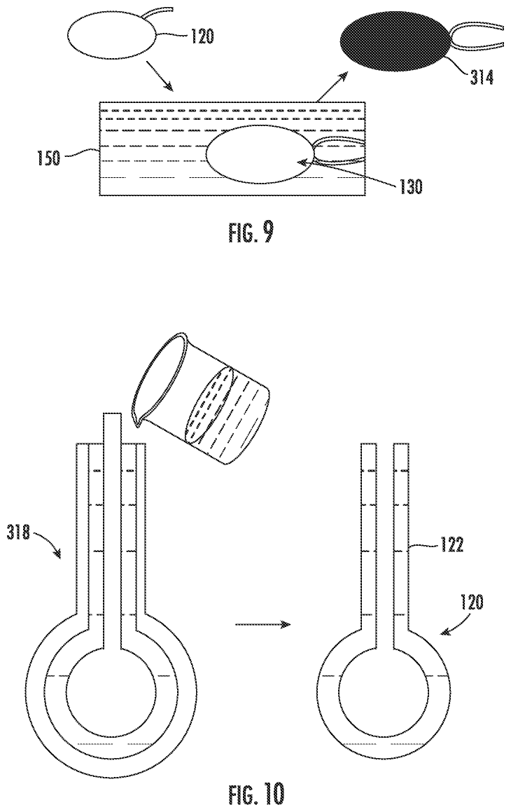

In some embodiments, inner fluid chamber 120 is formed from one or more layer of tissue material that is poured around a small mold, and surgical tubing is adhesively attached to inner fluid chamber 120 to serve as one or more first conduit 122 to provide access for the first fluid. Alternatively, inner fluid chamber 120 and one or more first conduit 122 can be formed as one coherent object made of the same material using an integrated mold 318 as shown in FIG. 10.

Regardless of the particular form of inner fluid chamber 120, inner fluid chamber 120 is positioned within outer fluid chamber 130, and the one or more first conduit 122 is inserted into one of the channels formed within torso model 150. In some embodiments, further tubing is provided in communication with another of the channels formed within torso model 150 to serve as the one or more second conduit 132 in communication with outer fluid chamber 130. Finally, the incision into torso model 150 can be sealed, such as by providing additional tissue material to bond with the material of torso model 150.

With a configuration according to any of the above described embodiments, heart model 110 can be used for simulating an infant pericardiocentesis procedure. In an aspect of the present subject matter, a method for pericardiocentesis training comprises providing an infant pericardiocentesis training device and/or system including an inner fluid chamber 120 and an outer fluid chamber 130 substantially surrounding inner fluid chamber 120 as disclosed herein, and manipulating a needle 220 into the training device and/or system while simultaneously observing the needle 220 by ultrasound and/or other imaging device 210. In some embodiments, such devices and systems can also be used for, or configured for use for, thoracentesis and/or intracardiac injection procedures.

Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one skilled in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novelcharacteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A medical procedure training device, comprising:
an inner fluid chamber;
a first conduit connected to the inner fluid chamber and configured to provide passage of a first fluid into or out of the inner fluid chamber;
an outer fluid chamber substantially surrounding the inner fluid chamber; and
a second conduit connected to the outer fluid chamber and configured to provide passage of a second fluid into or out of the outer fluid chamber.

2. The medical procedure training device of claim 1, wherein the device comprises a solid material having a density selected to produce a desired imaging response to ultrasound or other imaging system.

3. The medical procedure training device of claim 1, wherein the training device has a size and shape configured to model a heart of an infant patient or adolescent adult patient.

4. The medical procedure training device of claim 1, further comprising a torso model, wherein the inner fluid chamber and the outer fluid chamber are contained within the torso model, wherein the inner fluid chamber is configured to model a patient heart, wherein the outer fluid chamber is configured to model a pericardial space.

5. The medical procedure training device of claim 4, wherein the torso model comprises an outer surface on which simulated anatomical features are formed.

6. The medical procedure training device of claim 5, wherein the simulated anatomical features comprise one or more of ribs or a sternum.

7. The medical procedure training device of claim 5, wherein the inner fluid chamber and the outer fluid chamber are positioned within the torso model in a substantially anatomically correct location with respect to the simulated anatomical features.

8. The medical procedure training device of claim 1, wherein the inner fluid chamber and the outer fluid chamber are each delimited by one or more material layer comprising a solid material having a density that is substantially similar to human tissue density.

9. The medical procedure training device of claim 1, wherein the inner fluid chamber and the outer fluid chamber are each delimited by one or more material layer that comprises a material selected from the group consisting of a thermoplastic elastomer, a silicone, a synthetic ballistic tissue, a polymer, and combinations thereof.

10. A medical procedure training system, comprising:
a medical procedure training device comprising:
an inner fluid chamber;
a first conduit connected to the inner fluid chamber;
an outer fluid chamber substantially surrounding the inner fluid chamber; and
a second conduit connected to the outer fluid chamber;
a first fluid source in communication with first conduit and configured to provide passage of a first fluid into or out of the inner fluid chamber;
a second fluid source in communication with the second conduit and configured to provide passage of a second fluid into or out of the outer fluid chamber; and
an ultrasound device or other imaging device.

11. The medical procedure training system of claim 10, wherein the first fluid and the second fluid are each of a different color.

12. The medical procedure training system of claim 10, wherein one or both of the first fluid source or the second fluid source comprises a pump configured for circulating a respective one of the first fluid or the second fluid into the inner fluid chamber or the outer fluid chamber.

13. The medical procedure training system of claim 10, further comprising a torso model, wherein the inner fluid chamber and the outer fluid chamber are contained within the torso model;
wherein the torso model comprises an outer surface on which simulated anatomical features are formed; and
wherein the inner fluid chamber and the outer fluid chamber are positioned within the torso model in a substantially anatomically correct location of a heart with respect to the simulated anatomical features.

14. The medical procedure training system of claim 13, wherein the torso model is integrated into a doll or dummy.

15. A method of simulating an infant pericardiocentesis procedure, the method comprising:
providing a medical procedure training device including an inner fluid chamber and an outer fluid chamber substantially surrounding the inner fluid chamber; and
manipulating a needle into the training device while simultaneously observing the needle by ultrasound or other imaging device.

16. The method of claim 15, comprising supplying a first fluid into or out of the inner fluid chamber; and
supplying a second fluid into or out of the outer fluid chamber.

17. The method of claim 16, wherein the first fluid and the second fluid are each of a different color.

18. The method of claim 15, wherein the medical procedure training device comprises a torso model, wherein the inner fluid chamber and the outer fluid chamber are contained within the torso model.
